(19) United States
(12) Patent Application Publication
(10) Pub. No.: US 2008/0218852 A1
(43) Pub. Date: Sep. 11, 2008

(54) Viewing Systems for Selective Viewing of Artisan's Activities

(76) Inventor: Linor Latar, Caesarea (IL)

Correspondence Address: DR. MARK M. FRIEDMAN;C/O BILL POLKINGHORN - DISCOVERY DISPATCH, 9003 FLORIN WAY, UPPER MARLBORO, MD, 20772, US

(21) Appl. No.: 11/684,617

(22) Filed: Mar. 11, 2007

(51) Int. Cl. G02B 23/02

(52) U.S. Cl. 359/433

(57) ABSTRACT

A viewing system associated with a permanent building structure includes a first reflective optical arrangement, mechanically associated with the permanent building structure, for viewing by a person in a first location. The system also includes a passive optical projection system including at least a second reflective optical arrangement mechanically associated with the permanent building structure The optical projection system is deployed for projecting via the first reflective optical arrangement an image of a defined sub-region of an area within the permanent building structure not directly viewable from said first location. This allows a user at the first location to view the defined sub-region.

### FIELD AND BACKGROUND OF THE INVENTION

The present invention relates to optical systems and, in particular, it concerns passive viewing systems useful, for example, for allowing selective viewing of artisan's activities, and various related methods.

The periscope is a well known passive optical device which employs a combination of reflective optical elements (mirrors or prisms) to allow viewing of a scene via an indirect optical path. Periscopes are typically either free-standing portable devices or are incorporated into vehicles such as tanks and submarines to allow a person hidden from view to see the outside environment without exposing himself or moving from his place. Periscopes are not normally incorporated into permanent building structures, and are not normally configured to allow viewing of a region inside a building by those passing outside.

In the field of vehicle safety, more complex implementations of reflective optical viewing systems have been proposed to provide a driver with additional fields of vision. An example of such a system is described in U.S. Pat. No. 6,104,538 to Ben-Ghiath, which is hereby incorporated by reference in its entirety. FIGS. 4C and 4E of the Ben-Ghiath patent are illustrative of an optical arrangement for an articulated vehicle which provides a righted image (i.e., where the image is correctly oriented) despite angular rotation between reflectors of a complex periscope arrangement. Righting of the image is achieved using a dove prism or a hollow prism element.

Where products and services are offered by skilled artisans, it has been found very attractive to the public to watch the artisan at work. Thus, it has become common for restaurants to have at least part of their kitchen open-plan for the customers to see a skilled chef at work. Similarly, an art gallery may be more enticing to the public if they see an artist at work, and clients considering getting in line at a hairdresser, beauty parlor or for tattooing may be attracted by seeing the hairdresser, cosmetician or tattooist in action on a previous client.

Despite these advantages, exposed open-plan work environments are not always ideal. The artisan may be troubled by constant distractions which disturb his work. He may also suffer from a lack of privacy if he feels he needs to take a break, eat his lunch, shout at his co-worker or perform any other socially unacceptable or somewhat private activity Similarly, certain personal services such as tattooing or certain beauty treatments may require exposure of the client's body to an extent which would make the client uncomfortable in a publicly open place.

Even where an open-plan work environment would be an acceptable option, such arrangements are not always possible. Particularly in crowded urban settings, limited floor space near a shop front may make it impossible to locate the artisan's work space in direct view of potential customers Instead, the artisan may need to be located on a different level of the building, above or below the shop front.

There is therefore a need for a system and method which would allow controlled public exposure of activities performed by an artisan without encroaching unnecessarily on the privacy of the artisan or his clients.

### SUMMARY OF THE INVENTION

The present invention is a passive viewing system useful, for example, for allowing selective viewing of artisan's activities The invention also provides various methods related to such a system.

According to the teachings of the present invention there is provided, a viewing system associated with a permanent building structure, the viewing system including: (a) a first reflective optical arrangement mechanically associated with the permanent building structure and deployed for viewing by a person in a first location; and (b) a passive optical projection system including at least a second reflective optical arrangement mechanically associated with the permanent building structure, the optical projection system being deployed for projecting via the first reflective optical arrangement an image of a defined sub-region of an area within the permanent building structure not directly viewable from the first location, thereby allowing viewing of the defined sub-region by a user at the first location.

According to a further feature of the present invention, there is also provided a set of artisan's tools and a primary work surface deployed within the area, the defined sub-region including at least part of the primary work surface.

According to a further feature of the present invention, the set of artisan's tools are selected from the group consisting of, tattooing tools; jeweler's tools; cosmetic tools; hairdressing tools; carpentry tools; sculpturing tools; and culinary tools.

According to a further feature of the present invention, the primary work surface is selected from the group consisting of: an artist's easel; a chair for supporting a subject's body; and a bed for supporting a subject's body.

According to a further feature of the present invention, the first reflective optical arrangement is deployed within an opaque wall of the permanent building structure, and wherein the optical projection system projects the image along an optical path passing through a void within the opaque wall.

According to a further feature of the present invention, the first reflective optical arrangement is deployed as part of a window display.

According to a further feature of the present invention, the optical projection system is configured such that the defined sub-region is located on a different level of the permanent building structure from the first location.

According to a further feature of the present invention, the optical projection system includes at least one obscuring element for delimiting a field of view of the reflective viewing system.

According to a further feature of the present invention, the optical projection system includes at least one obscuring element selectively deployable to temporarily interrupt projection of the image.

According to a further feature of the present invention, the optical projection system includes an adjustable arrangement configured to allow selective shifting of the sub-region.

According to a further feature of the present invention, the optical projection system includes an optical arrangement for rotating an orientation of the image.

According, to a further feature of the present invention, the optical projection system includes an actuator for moving at least one element in a scaling motion so as to scan the sub-region across at least part of the area.

According to a further feature of the present invention, the optical projection system further includes an optical arrangement for rotating an orientation of the image, the optical arrangement being linked to the actuator so as to maintain an orientation of the image substantially constant during the scanning motion.

According to a further feature of the present invention, the optical projection system includes magnifying optics for enlarging a view of the sub-region as viewed from the first location.

There is also provided according to the teachings of the present invention, a method for providing selective visual access to the activities of an artisan comprising the steps of: (a) providing a work space for the artisan in a location normally obscured from view from an adjacent public place; (b) designating within the work space a sub-region within which the artisan is to perform at least a first set of activities; and (c) deploying a passive optical system including a plurality of reflective optical arrangements, the passive optical system being deployed so as to allow viewing of the sub-region from the adjacent public place without allowing viewing of regions of the work space outside the sub-region.

There is also provided according to the teachings of the present invention, a method for arranging a work environment for an artisan comprising the steps of: (a) providing a work space in a location normally obscured from view from an adjacent public place; (b) arranging in a first sub-region of the work space a first set of tools for performance of a first set of operations; (c) arranging in a second sub-region of the work space a set of objects selected from the group consisting of; a second set of tools for performance of a second set of operations different from the first set of operations; and a set of personal convenience items unrelated to performance of the first set of operations; and (d) deploying a passive optical system including a plurality of reflective optical arrangements, the passive optical system being deployed so as to allow viewing of the first sub-region of the work space from the adjacent public place without allowing viewing of the second sub-region of the work space.

### BRIEF DESCRIPTION OF THE DRAWINGS

The invention is herein described, by way of example only, with reference to the accompanying drawings, wherein:

FIG. 1 is a schematic isometric representation of a first embodiment of a passive viewing system, constructed and operative according to the teachings of the present invention;

FIG. 2 is a schematic isometric representation of a second embodiment of a passive viewing system, constructed and operative according to the teachings of the present invention;

FIG. 3A is a schematic view of an activity being performed by an artisan on an exposed body portion of a client;

FIG. 3B illustrates a selective field of view of the activity of FIG. 3A offered by the system of FIG. 1 or FIG. 2; and

FIG. 4 is a schematic side view of a scanning optical system for use in an implementation of the system of FIG. 1 or FIG. 2.

### DESCRIPTION OF THE PREFERRED EMBODIMENTS

The present invention is a passive viewing system useful, for example, for allowing selective viewing of artisan's activities. The invention also provides various methods which may be implemented with such a system.

The principles and operation of systems and methods according to the present invention may be better understood with reference to the drawings and the accompanying description.

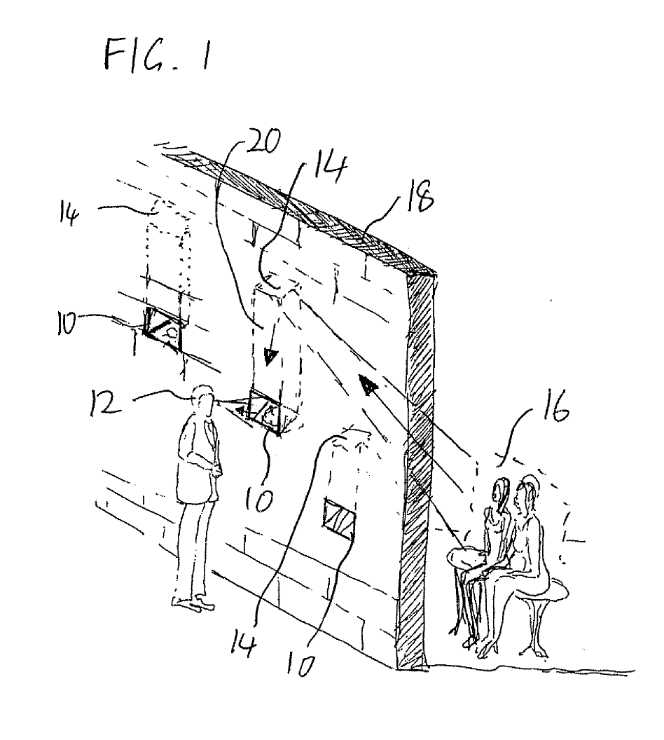

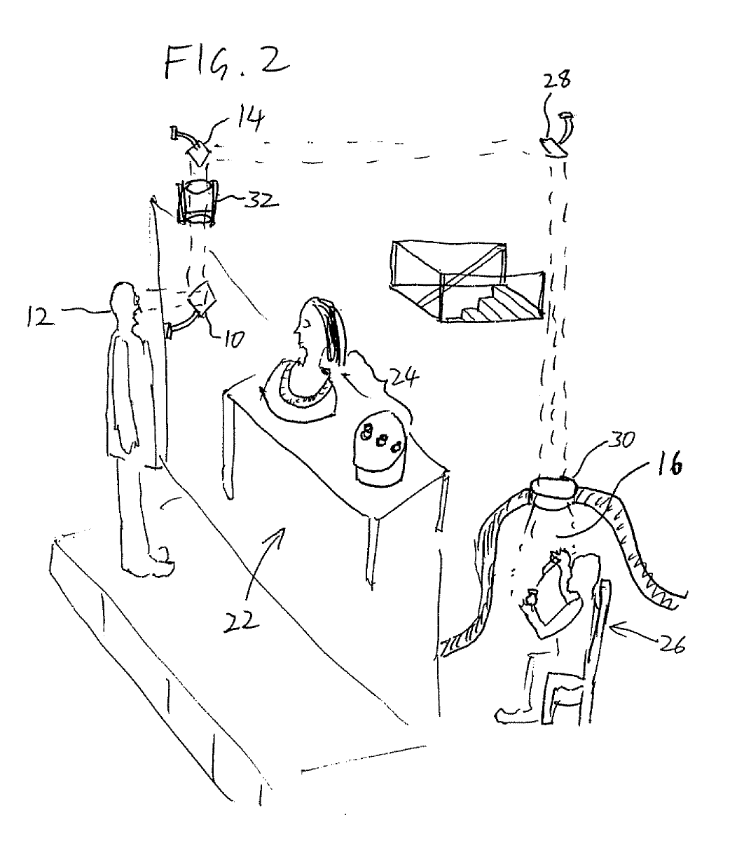

Referring now to the drawings, FIGS. 1 and 2 show two embodiments of a viewing system, constructed and operative according to the teachings of the present invention, associated with a permanent building structure. In general terms, the viewing system includes a first reflective optical arrangement 10, mechanically associated with the permanent building structure, deployed for viewing by a person in a first location 12. The viewing system also includes a passive optical projection system including at least a second reflective optical arrangement 14 mechanically associated with the permanent building structure. The optical projection system is deployed so as to project via first reflective optical arrangement 10 an image of a defined sub-region 16 of an area within the permanent building structure not directly viewable from the first location, thereby making the defined sub-region 16 visible to a user at the first location 12.

At this stage, it will already be apparent that the present invention provides a highly advantageous solution to the aforementioned problems of controlled visibility of an artisan at work. The viewing system provides controllable and selective exposure of activities performed within an area of a building which would not otherwise be visible from the first location, and allow activities not for public display to be performed outside the field of view of the system. This and other advantages of the invention will be better understood from the following detailed description.

Before turning to the various embodiments of the present invention in more detail, it will be useful to define certain terminology as used herein in the description and claims. Firstly, the present invention relates to “passive optical systems”. The term “passive” in this context refers to an optical system which conveys to the eye of the viewer light which was reflected from the viewed scene. The term “passive” is used herein to distinguish the system of the present invention from camera systems where an image is sensed, turned into an electronic signal (digital or analog) and then displayed on a screen or via other display technology. Passive optical systems are chosen for implementing the present invention due to their low cost, low maintenance and independence of power sources.

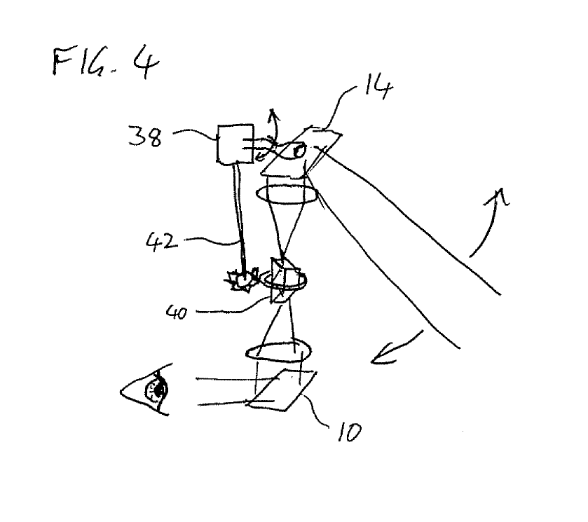

The term “reflective optical system” is used herein to refer to an optical system wherein at least part of the optical path is folded or deflected by reflection. This term does not exclude the possibility that various refractive or diffractive optical elements are included in the system, for example, such as those that will be described with reference to FIGS. 2 and 4 below.

The term “projection” is used herein in the description and claims to refer to the function of collecting light from a scene and directing the collected light along an optical path in a manner which allows it to be viewed. The term encompasses both cases where the optical system generates a real image (i.e., which would be visible on an appropriately placed screen) and cases where the optical system generates an imaginary image which is viewable. Furthermore, the optical projection system may require additional optical elements, such as an eyepiece or the like, to render the image viewable,

The term “sub-region” is used to refer to any portion of a larger area or region which falls within the field of view (FOV) of the optical system.

The present invention relates primarily to viewing systems which are mechanically associated with a permanent building structure. The building structure may be any building structure formed from any type of construction. In certain embodiments of the invention, some or all of the components of the viewing system are integrated into the structural elements of the building itself, such as walls, floors etc. In other embodiments, the components of the viewing system are mounted rigidly or movably by attachment to the building structure.

Finally with regard to terminology, reference is made to applications of the invention relating to an artisan and his tools. The term “artisan” is used herein in the description and claims to refer to any person who performs a trade, craft, entertainment, or provides a service (all referred to generically as an “activity”) where the activity requires some degree of skill, ability, knowledge and/or qualification not common to a majority of the general population, and where the activity is performed primarily manually (by hand or by use of manually manipulated tools) or by another part of the body. Examples of artisans according to this definition include, but are not limited to: tattooists; jewelers; cosmeticians; hairdressers; carpenters; artists; sculptors; and chefs.

Turning now to features of preferred embodiments of the present invention in more detail. FIG. 1 shows a first embodiment in which first reflective optical arrangement 10 is deployed within an opaque wall 18 of the permanent building structure. In this case, the optical projection system preferably projects the image along an optical path passing through a void 20 within the opaque wall. This embodiment turns an otherwise opaque wall into a display system through which people outside the building can be shown selective items, views or activities occurring within the building. Thus, for example, the area immediately adjacent to the back of the wall may be utilized for functional purposes (e.g., for storage) while the sub-region displayed via the viewing system is located some distance away from wall 18.

Optionally, a plurality of viewing systems may be combined within the wall to provide views of different sub-regions and/or views of the same sub-region from different angles. In this way, a single wall may provide views of a plurality of sub-regions located in disparate locations within the building which could not otherwise be combined in a single display window.

Turning now to FIG. 2, there is shown an alternative implementation of a viewing system, constructed and operative according to the teachings of the present invention, where first reflective optical arrangement 10 is deployed as part of a window display 22. Window display 22 typically includes a plurality of items, in this case jewelry 24, on display behind a transparent window. This conventional display is supplemented by a view of a sub-region remote from the display window, exemplified here by a jeweler 26 working on a level of the building one floor below the level of the window display. The floor of the upper level of the building is shown here partially cut away for clarity of presentation.

The embodiment of FIG. 2 also illustrates an implementation of the optical projection system which includes various additional optical components Specifically, second reflective optical arrangement 14 is here supplemented by a third reflective optical arrangement 28, a field-widening objective lens arrangement 30, and magnifying optics (effectively a telescope 32) for magnifying the view, thereby compensating for the relatively long optical path from the viewer to the sub-region viewed It will be appreciated that additional similar components, and various other generally known optical components, may be added as necessary for the circumstances of each implementation.

In the non-limiting example illustrated here, reflective optical arrangements 10, 14 and 28, and telescope 32 are mounted via appropriate brackets to internal surfaces (not shown) of the building structure Objective lens arrangement 30, on the other hand, is in this case incorporated into the floor between levels of the building.

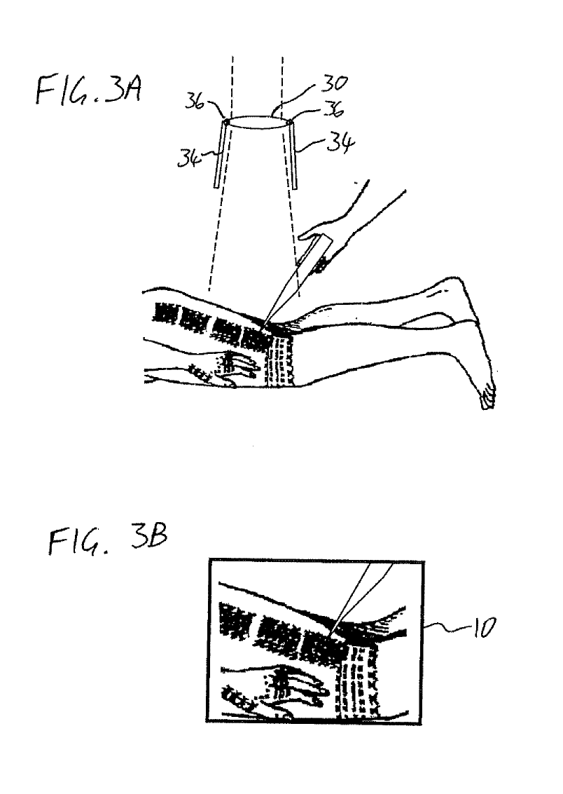

Turning not to FIGS. 3A and 3B, the present invention may be used in various circumstances where it is desirable to limit the field of view of the viewing system to a well defined sub-region and/or to adjust the field of view during operation of the system. For example, FIG. 3A shows a case where a tattooist is applying a tattoo to a part of the body which requires exposure of the upper legs and buttocks of the subject In some cases, the inherent optical field of view may be sufficiently well defined and localized. Optionally, additional control of the field of view is allowed by providing at least one obscuring element 34 for delimiting a field of view of the system. Preferably, obscuring elements 34 are adjustably mounted, such as at hinges 36, to allow adjustment of the extent to which they limit the field of view. According to a further preferred option, at least one obscuring element 34 is selectively deployable to temporarily interrupt projection of the image, thereby temporarily providing privacy. FIG. 3B illustrates the view at first location 12 via first reflective optical arrangement 10 after obscuring elements 34 have been adjusted to avoid undesirable exposure of the subject's body via the viewing system.

Turning now to FIG. 4, it is a preferred feature of certain embodiments of the present invention that the optical projection system includes an adjustable arrangement configured to allow selective shifting of the sub-region viewed. In a simple implementation, this may be achieved by mounting a reflector of the optical projection system on a pivotal or otherwise adjustable joint. According to a further option, the optical projection system may include an actuator 38 for moving at least one element in a scanning motion so as to scan the sub-region across at least part of the area. This provides a dynamically varying view which may be useful in a range of circumstances. For example, a scanning motion may provide an overview of the available selection of goods arrayed at a location within a store. According to certain embodiments, a user control (not shown) may be provided to allow a user within the building, or alternatively the viewer outside the building, to control the motion. Alternatively, the motion may be a cyclically repeated motion which occurs continuously or intermittently.

It will be noted that relative angular motion between reflective elements in a periscope arrangement tends to result in rotation of the orientation of the viewed image. Various optical arrangements may be used to correct this rotation and right the image to the intuitive orientation, i.e. where a line vertical in the field of view appears vertical in the image as viewed. Preferred options for an optical arrangement for rotating the orientation of the image include, but are not limited to, a dove prism 40 or a hollow prism (not shown). Most preferably, the prism is driven, either by mechanical linkage 42 to actuator 38 or by a separate synchronized actuator, to rotate in a defined relation relative to the scanning motion of the optical projection system field of view, thereby providing a correctly oriented view throughout the scanning motion.

Further details of such arrangements for righting a viewed image under conditions of rotation of a reflective system may be found in the aforementioned U.S. Pat. No. 6,104,538 to Ben-Ghiath.

Turning now to applications of the viewing system described above, and corresponding methods according to the teachings of the present invention, it is possible to provide selective visual access to the activities of an artisan according to the teaching of the present invention by: (a) providing a work space for the artisan in a location normally obscured from view from an adjacent public place; (b) designating within the work space a sub-region within which the artisan is to perform at least a first set of activities; and (c) deploying a passive optical system such as those described above so as to allow viewing of the sub-region from the adjacent public place without allowing viewing of regions of the work space outside the sub-region.

In certain cases, where the workspace is to be used for a first set of activities which are more skilled or more “glamorous” (e.g., flipping omelets) and a second set of activities which are less “glamorous” (erg., peeling potatoes), the workspace is preferably set up with tools for performing the first set of activities in the first sub-region and tools for performing the second set of activities in a second sub-region which is not viewable via the viewing system.

The tools in question may be any tools required by an artisan for the relevant activities to be performed. Preferred examples include, but are not limited to, tattooing tools; jeweler's tools; cosmetic tools; hairdressing tools; carpentry tools; sculpturing tools; and culinary tools.

Depending upon the type of artisan involved, the first region may also include at least part of a primary work surface employed by the artisan In addition to work tables used by many artisans, other non-limiting examples of distinctive work surfaces include: an artist's easel; a chair for supporting a subject's body; and a bed for supporting a subject's body.

It will be appreciated that the above descriptions are intended only to serve as examples, and that many other embodiments are possible within the scope of the present invention as defined in the appended claims.

What is claimed is:

1. A viewing system associated with a permanent building structure, the viewing system including:
(a) a first reflective optical arrangement mechanically associated with the permanent building structure and deployed for viewing by a person in a first location; and
(b) a passive optical projection system including at least a second reflective optical arrangement mechanically associated with the permanent building structure, said optical projection system being deployed for projecting via said first reflective optical arrangement an image of a defined sub-region of an area within the permanent building structure not directly viewable from said first location, thereby allowing viewing of said defined sub-region by a user at said first location.

2. The viewing system of claim 1, further comprising a set of artisan's tools and a primary work surface deployed within said area, said defined sub-region including at least part of said primary work surface.

3. The viewing system of claim 2, wherein said set of artisan's tools are selected from the group consisting of, tattooing tools; jeweler's tools; cosmetic tools; hairdressing tools; carpentry tools; sculpturing tools; and culinary tools.

4. The viewing system of claim 2, wherein said primary work surface is selected from the group consisting of: an artist's easel; a chair for supporting a subject's body; and a bed for supporting a subject's body.

5. The viewing system of claim 1, wherein said first reflective optical arrangement is deployed within an opaque wall of the permanent building structure, and wherein said optical projection system projects said image along an optical path passing through a void within said opaque wall.

6. The viewing system of claim 1, wherein said first reflective optical arrangement is deployed as part of a window display.

7. The viewing system of claim 1, wherein said optical projection system is configured such that said defined sub-region is located on a different level of the permanent building structure from said first location.

8. The viewing system of claim 1, wherein said optical projection system includes at least one obscuring element for delimiting a field of view of said reflective viewing system.

9. The viewing system of claim 1, wherein said optical projection system includes at least one obscuring element selectively deployable to temporarily interrupt projection of said image.

10. The viewing system of claim 1, wherein said optical projection system includes an adjustable arrangement configured to allow selective shifting of said sub-region.

11. The viewing system of claim 10, wherein said optical projection system includes an optical arrangement for rotating an orientation of said image.

12. The viewing system of claim 1, wherein said optical projection system includes an actuator for moving at least one element in a scanning motion so as to scan said sub-region across at least part of said area.

13. The viewing system of claim 12, wherein said optical projection system further includes an optical arrangement for rotating an orientation of said image, said optical arrangement being linked to said actuator so as to maintain an orientation of said image substantially constant during said scanning motion.

14. The viewing system of claim 1, wherein said optical projection system includes magnifying optics for enlarging a view of said sub-region as viewed from said first location.

15. A method for providing selective visual access to the activities of an artisan comprising the steps of;
(a) providing a work space for the artisan in a location normally obscured from view from an adjacent public place;
(b) designating within said work space a sub-region within which the artisan is to perform at least a first set of activities; and
(c) deploying a passive optical system including a plurality of reflective optical arrangements, said passive optical system being deployed so as to allow viewing of said sub-region from the adjacent public place without allowing viewing of regions of said work space outside said sub-region.

16. A method for arranging a work environment for an artisan comprising the steps oft
(a) providing a work space in a location normally obscured from view from an adjacent public place;
(b) arranging in a first sub-region of said work space a first set of tools for performance of a first set of operations;
(c) arranging in a second sub-region of said work space a set of objects selected from the group consisting of; a second set of tools for performance of a second set of operations different from said first set of operations; and a set of personal convenience items unrelated to performance of said first set of operations; and
(d) deploying a passive optical system including a plurality of reflective optical arrangements, said passive optical system being deployed so as to allow viewing of said first sub-region of said work space from the adjacent public place without allowing viewing of said second sub-region of said work space.
